(19) United States
(12) Patent Application Publication
(10) Pub. No.: US 2025/0161154 A1
(43) Pub. Date: May 22, 2025

(54) DEVICE AND METHOD TO INDUCE INTERFERENTIAL BEAT VIBRATIONS AND FREQUENCIES INTO THE BODY

(71) Applicant: The Chair Fix LLC, Orem, UT (US)

(72) Inventors: Kim H. Manwaring, Heber City, UT (US); Scott C. Steffensen, Provo, UT (US); Kyle B. Bills, Springville, UT (US); Jonathon D. Blotter, Heber City, UT (US); Jeffrey Brent Feland, Orem, UT (US)

(21) Appl. No.: 19/030,992

(22) Filed: Jan. 17, 2025

Related U.S. Application Data
(63) Continuation-in-part of application No. 17/437,386, filed on Sep. 8, 2021, now Pat. No. 12,226,361.
(60) Provisional application No. 62/815,981, filed on Mar. 8, 2019.
(60) Provisional application No. 62/837,638, filed on Apr. 23, 2019.
(60) Provisional application No. 62/863,160, filed on Jun. 18, 2019.
(60) Provisional application No. 63/623,195, filed on Jan. 19, 2024.

(51) Int. Cl. A61H 23/02; A61H 1/00

(52) U.S. Cl. CPC A61H 23/02; A61H 1/005; A61H 2201/1215; A61H 2201/1633; A61H 2201/5005; A61H 2201/5043; A61H 2205/02; A61H 2205/086

(57) ABSTRACT

A therapeutic device. The therapeutic device includes a unified seat and/or a top shell and a bottom shell. A first vibrator is connected to a first portion of the unified seat and is configured to cause a first vibration at the first portion of the unified seat. A second vibrator is connected to a second portion of the unified seat and is configured to cause a second vibration at the second portion of the unified seat. The second vibration has a different frequency than the first vibration resulting in a low frequency traveling wave that propagates to a patient's head.

### CROSS REFERENCE TO RELATED APPLICATIONS

This application is a continuation in part to U.S. patent application Ser. No. 17/437,386 filed Sep. 8, 2021, entitled “A DEVICE AND METHOD TO INDUCE INTERFERENTIAL BEAT VIBRATIONS AND FREQUENCIES INTO THE BODY”, which is a 371 national phase of PCT/US2020/029626, filed Apr. 23, 2020, entitled “A DEVICE AND METHOD TO INDUCE INTERFERENTIAL BEAT VIBRATIONS AND FREQUENCIES INTO THE BODY”, and claims the benefit of U.S. Provisional Application No. 62/815,981, filed Mar. 8, 2019, entitled “ENHANCEMENT OF BRAIN DOPAMINE LEVELS AND DEPRESSION OF GABA NEURONS BY NON-INVASIVE VIBRATORY STIMULATION”, U.S. Provisional Application No. 62/837,638, filed Apr. 23, 2019, entitled “DEVICE AND METHOD TO INDUCE INTERFERENTIAL BEAT VIBRATIONS AND FREQUENCIES INTO THE BODY FOR TREATMENT OF PAIN, ANXIETY, DEPRESSION, ADDITION, AND SLEEP DISORDERS”, U.S. Provisional Application No. 62/863,160, filed Jun. 18, 2019, entitled “DEVICE AND METHOD TO INDUCE INTERFERENTIAL BEAT VIBRATIONS AND FREQUENCIES INTO THE BODY”, and claims the benefit of U.S. Provisional Application No. 63/623,195 filed on Jan. 19, 2024, entitled “A DEVICE AND METHOD TO INDUCE INTERFERENTIAL BEAT VIBRATIONS AND FREQUENCIES INTO THE BODY”, which applications are expressly incorporated herein by reference in their entirety.

This invention was made with government support under Grant Numbers AA020919, DA035958 and F32AT009945 awarded by the National Institutes of Health. The government has certain rights in the invention.

### BACKGROUND

Dopamine (DA) functions as a neurotransmitter and hormone in humans and a wide variety of vertebrates and invertebrates. It is associated with emotional behavior, cognition, voluntary movement, motivation, punishment, and reward. Dopamine is produced in several brain areas, including the midbrain substrantia nigra (SN), VTA, and hypothalamus. The primary function of the midbrain SN DA system, termed the nigrostriatal system, is for initiating and terminating planned movement and involves DA neurons that project to the dorsal striatum; the VTA DA system, termed the mesolimbic system, is for motivation and involves DA neurons that originate in the midbrain VTA and project to the ventral striatum, otherwise known as the nucleus accumbens (NAc); and the hypothalamic DA system, whose function is to inhibit the release of prolactin from the anterior lobe of the pituitary. The nigrostriatal and mesolimbic DA systems exhibit analogous neurons, circuits, neurotransmitters, and receptors. The mesolimbic DA system (Koob, 1992; Bloom, 1993; Kalivas et al., 1993; Schultz et al., 1997) constitutes part of the brain reward system that has evolved for mediating natural motivated behaviors such as feeding (Phillips et al., 2003), drinking (Agmo et al., 1995), and drug reward [including alcohol reward (Koob, 1996)]. There is considerable evidence demonstrating that DA release in the NAc induces a motivational drive and that the DA signal is modulated by past experience of reward and punishment (Oleson et al., 2012; Howe et al., 2013). Mesolimbic DA is believed to be a teaching signal which codes the magnitude of aversive and rewarding stimuli (Howe et al., 2013). The mesolimbic dopamine (DA) circuit originates in the ventral tegmental area (VTA) of the midbrain and terminates in the nucleus accumbens (NAc) of the striatum. Dopamine release within the mesolimbic circuit has been implicated in both associative learning and motivation (Schultz, Apicella, & Ljungberg, 1993; Wise, 2004). Preferential increases in DA release within the NAc are a hallmark of drugs of abuse (Di Chiara & Imperato, 1988), literally a scalar index of reward, suggesting that the abuse potential of a drug is tied to its ability to increase DA release within the NAc. The prevailing view is that drugs are initially consumed for their positive reinforcing properties, but that over time the maintenance of drug seeking is driven by the ability of the drug to alleviate the symptoms of withdrawal (Koob, 2014; Koob & Le Moal, 1997; Koob & Volkow, 2010, 2016). This progression from positive to negative reinforcement is, at least in part, the result of changes within the mesolimbic DA system. Acute administration of most drugs of abuse increase DA release in the NAc (Di Chiara & Imperato, 1985; Imperato & Di Chiara, 1986; Yim & Gonzales, 2000) whereas chronic consumption results in a protracted decrease in NAc DA levels during withdrawal (Weiss et al., 1996). This protracted decrease in NAc DA levels creates an anhedonic state in which individuals are more likely to seek out and consume drugs to increase DA levels in the NAc and thus diminish the feelings of dysphoria. This is often referred to as the negative reinforcement properties of ethanol, or the “dark side” of addiction.

Dysregulated DA transmission has been implicated in the allostatic properties of drugs of abuse (Wise, 2004). The dogma is that any drug or behavior that increases midbrain DA neuron activity will be rewarding, and potentially addictive (Kalivas et al., 1993; Nestler, 2001; Kalivas & Volkow, 2005). However, the neurobiology of the addiction process certainly involves multiple, complex neural circuits including the mesolimbic DA system (Diana et al., 2008; Steffensen et al., 2008; Olsson et al., 2009; 2009). Notwithstanding the complexity, the prevailing view is that people consume drugs for their rewarding properties, which are mediated by this system. Drugs enhance DA release resulting in feelings of pleasure, euphoria, and well-being. The level of DA release by some drugs of abuse can be 10 times that produced by natural rewarding behaviors such as eating, drinking, and sex. However, the onslaught of DA release is transient and often results in adaptations including progressive, compensatory lowering of baseline DA levels. Addicts continue their cycle of abuse, in part, as a result of maladapted and depleted DA levels, resulting in feelings of anxiety and dysphoria that drives subsequent drug-seeking behavior. Although this model seems straightforward in concept, it is likely over-simplistic in scope, as DA release may only be one determinant of addiction, as the DA projection from the VTA to the NAc is only part of a larger motivational circuit that includes cortical and subcortical structures. Indeed, modifications in DA release may be an epiphenomenon of a larger maladaptive process involving multiple neuronal substrates and inputs. Regardless, tolerance accrues to repeated drug use, resulting ultimately in persistently lowered DA release in the NAc. Although addiction begins as a personal choice to consume a drug or other reinforcer, the motivation to continue to seek the reinforcing stimulus is influenced greatly by genetic, environmental and experiential factors, leading to a spiraling dysregulation of brain DA with intermittent exposure to the reinforcer. The emerging view is that the impaired homeostasis that accompanies the development of drug addiction may result from experience-dependent neuroadaptations that usurp normal synaptic transmission in this system (Hyman & Malenka, 2001; Hyman et al., 2006; Kauer & Malenka, 2007; Nugent & Kauer, 2008). This maladapted state is associated psychologically with anxiety and behaviorally with drug-seeking behavior. The severity of associated symptoms and signs can for some drugs of abuse like alcohol can be life-threatening and the re-dosing behavior can frequently lead to overdose and death. The addicting substances are typically nonspecific in stimulation and may also include overstimulation of selective central receptors in the pain pathway among others.

### BRIEF SUMMARY

In the clinical management of addiction, various strategies to mitigate withdrawal symptoms are employed until the patient no longer experiences the craving and the symptoms have fully subsided. This may involve methods of titration, substitution, and even aversion. Among all of these approaches, signaling of anxiety as a subjective perception of worry, unease, and nervousness is a prodrome which must be ameliorated (Piper et al., 2011). Sometimes prescription drugs, for example in the benzodiazepine class, can mitigate this mind state. Multiple ancillary strategies have been showed to benefit, including acupuncture, yoga, hypnosis, and psychotherapy. However, it is apparent that intervention must be readily available, including the home environment, to be an effective bridge.

Bills, Steffensen et al (Bills et al., 2019) have recently shown in a mouse model that the central pathway of stimulation resulting in dopamine release can be controllably activated by peripheral mechanoreceptor stimulation, in some implementations optimally in the range of 45-80 Hz and predominantly at receptors in the cervical spine region. Such stimulation causes a release of dopamine in the NA with a prolonged duration of many minutes beyond cessation, the so-called afterglow effect. It is reasonable to hypothesize that such physical stimulation can function as a benign, repeatable bridge through symptoms and signs of withdrawal. As such, an on-demand availability of a device to which a patient can resort while in withdrawal could immediately ameliorate symptoms and signs, but specifically prevent progression beyond anxiety.

Yet further, recent studies from Martorell and Tsai (Martorell et al., 2019) have suggested additive therapeutic effects when other sensory modalities have been employed in cognitive enhancement in an animal model of Alzheimer's disease. Similarly, Clements-Cortex (Clements-Cortes et al., 2016) has shown that rhythmic visual and auditory stimulation may be beneficial to cognitive function. In the disclosed system and method, the tactile activation of mechanoreceptors by vibration may be augmented in the brain by similarly entrained pulses in the visual and auditory systems. The system and method have also been adapted to induce synchronized multi-modality sensory input into the brain, including differential frequencies to induce the beat effect.

To this end, the inventors have developed a device and method for introducing vibrations to patient as a way to reduce symptoms and anxiety to a patient. Specifically a therapeutic device may comprise a unified seat wherein the unified seat is monolithic in construction and configured for supporting a patient and for transferring vibration into the patient's body, a first vibrator connected to a first portion of the unified seat and configured to cause a first vibration to propagate from the first portion of the unified seat, and a second vibrator connected to a second portion of the unified seat and configured to cause a second vibration to propagate from the second portion of the unified seat, the second vibration having a different frequency than the first vibration, wherein the resulting interference comprises a low frequency traveling wave that propagates from the unified seat to the patient's head.

In a method for treating anxiety in a subject, the method may comprise uprightly positioning a subject on a unified seat comprising a first vibration contact and second vibration contact, wherein the subject's first ischial tuberosity is positioned over the first vibration contact and the subject's second ischial tuberosity is positioned over the second vibration contact, activating a first vibration source connected to the first vibration contact so that the first vibration source generates a first vibration at or between about 15 and 30 Hz, and activating a second vibration source connected to the second vibration contact so that the second vibration source generates a second vibration at or between about 15 and 30 Hz, the second vibration having a frequency different than the first vibration, the first vibration and second vibration differing in frequency by between 0.5 Hz and 2 Hz.

In another embodiment of a therapeutic device of the present disclosure, the therapeutic device may comprise a top shell of rigid construction configured for supporting a patient and for transferring vibration into the patient's body, a vibrator connected to a first portion of the top shell and configured to cause a first vibration to propagate from the first portion of the top shell, a second vibrator connected to a second portion of the top shell and configured to cause a second vibration to propagate from the second portion of the top shell, the second vibration having a different frequency than the first vibration, wherein the resulting interference comprises a low frequency traveling wave that propagates from the top shell to the patient's head, a bottom shell of rigid construction configured to be coupled to the top shell, an open-ended suspension mechanically coupled to top shell and configured to vibrationally isolate the top shell from the bottom shell, and a plurality of vibration isolators secured between the open-ended suspension and the top shell configured to limit vibrational propagation from the top shell to the bottom shell and base.

### BRIEF DESCRIPTION OF THE DRAWINGS

FIG. 1a is a posterior view of a seated subject on the vibration contacts with transducers directly beneath each ischial spine.

FIG. 1b is an anterior view of a seat with transducers affixed to each half of the seat.

FIG. 2a is a posterior view of a seated subject with transducers positioned to transmit maximal vertical displacement vibration into the pelvis through separately controllable units.

FIG. 2b is a posterior view of seat that can be adjusted for height, tilt, and width.

FIG. 3 is a schematic diagram of waveform drive control for each of the transducers.

FIG. 4 is a frontal view of a seated patient with a vibration transducer.

FIG. 5a is a real time plot of inductive coil sensors affixed to each of the transducer units.

FIG. 5b is another real plot of inductive coil sensors affixed to each of the transducer units driven at 26.7 and 27.7 Hz.

FIG. 5c is a plot of an induced frequency in the 45-80 Hz range.

FIG. 5d is a plot of a phase lock between the two drive frequencies at 15 degrees.

FIG. 6a is a perspective view of a customized mouth guard integrating a piezo vibration sensor.

FIG. 6b is a real time plot of the vibrational sensor from the mouth guard.

FIG. 7 is a real time plot of mouth guard signal and vibration drive signal.

FIG. 8 is a plot of the volitional squeeze by a subject of a piezo force sensor to track induced beat frequencies.

FIG. 9 is a schematic diagram where the tactile mechanoreceptor input into the body has been augmented to include auditory pulse input and visual pulse input.

FIG. 10 is a schematic diagram illustrating remote monitoring of the therapeutic session.

FIG. 11 illustrates another embodiment of a therapeutic device comprising a monolithic seat design of the present disclosure.

FIG. 12 illustrates an open-ended suspension assembly of the therapeutic device illustrated in FIG. 11.

FIG. 13A illustrates a front-perspective view of a therapeutic device of the present disclosure.

FIG. 13B illustrates a rear perspective view of a therapeutic device, as shown in FIG. 13A.

FIG. 13C illustrates a side cross-sectional view of the therapeutic device, as shown in FIG. 13A.

FIG. 13D illustrates a low front perspective view of the therapeutic device, as shown in FIG. 13A.

FIG. 13E illustrates the same perspective view shown in FIG. 13D, except that the bottom shell is made transparent.

FIG. 13F illustrates a high-front perspective of the therapeutic device, as shown in FIG. 13A, except that the top shell is made transparent.

FIG. 14 illustrates a cross-sectional view of another therapeutic device of the present disclosure.

### DETAILED DESCRIPTION

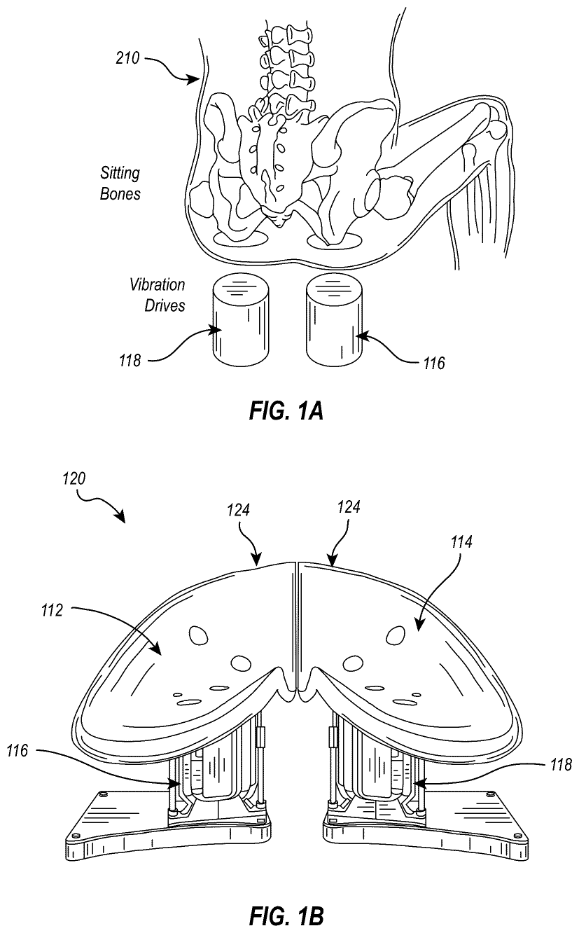

Turning now to FIG. 1a, a skeletal depiction of a seated subject upon a seat is illustrated. In this implementation, a first vibration contact 112 may be a first portion of a seat and a second vibration contact 114 may be a second portion of a seat. Although, it is understood that the vibration contacts could take the form of pad or plates that may be fixed in location and act to support the body. Further, the vibration contacts may be wearable or fastenable to the body through adhesive or a harness arrangement allowing the vibration contacts to move with the body. Each vibration contact (e.g. portion of the seat) may be independent from the other vibration contact (e.g. not attached) allowing each portion to vibrate independently from one another. As shown, the right ischial tuberosity may contact one portion of the seat and the left ischial tuberosity may contact the second portion of the seat. Beneath each ischial tuberosity of the pelvis, a first vibration source 116 may be connected to the first vibration contact 112 and a second vibration source 118 may be connected to the second vibration contact 114. In the example shown, the vibration sources may be a low frequency effects (LFE) transducer, although it is understood that other vibrations sources may be used comprising at least one of electromagnetic drivers, piezo-electric drivers, displacement shakers, solenoids, pneumatic or hydraulic actuators, and electric motors with unbalanced weights, cams, linear resonance actuators, piezoelectric actuators, or crankshafts. In some implementations, each vibration contact (e.g. each sagittal half of a seat) can be vibrated at the same frequency with 0° to 180° of relative phase. Each vibration contact can be vibrated at frequencies offset from each other such as to induce an interferential beat frequency as the difference between the two driving frequencies. In some implementations, each vibration contact (e.g. each sagittal half of a seat) can be vibrated with different frequencies. Each vibration contact can be vibrated independently with various waveforms in a range of 5-200 Hz to induce beat frequencies in the range of 0.05 Hz to 200 Hz which can be perceived as a traveling wave from pelvis to cranium. As such, each vibration contact can be vibrated independently to induce localized vibrational maxima into the head and/or cervical spine by use of phased inputs or beat frequencies. The vibration drives may also be such that the input vibration waves superimpose external to the body resulting in a beat frequency wave being directly input to the body.

FIG. 1b shows an anterior view of a self-centering deep pan seat 120 which has been divided into two halves (e.g. a first and second vibration contact 112, 114), each half resting on a vibrator (e.g. a first and second vibration source 116, 118). The self-centering deep pan seat 120 may also be referred to as a conforming, self-centering seat 120, a deep pan seat 120, and/or a conformal, dual-vibrating seat 120. The transducers may sit at an elevated height off the floor for a subject's normal seat height. The spacing between halves may be adjustable to assure the lateral thighs are snugly conformed by the deep pan. A raised surface 122 of the middle portion of the seat aids in self-centering the subject on the seat and providing alignment and contact of the subject's lateral thighs and spine to transmit the vibration to the subject from the seat. Further, a raised edge 124 around the outside of the seat forming the pan aids in centering and alignment, as well. The vibrators can induce vibration into the pelvis by the impulse movement of a vertically oriented magnetic piston which is controlled by a high current coil circumferentially wound. One exemplary vibration source may be the Buttkicker first low frequency effect (LFE) Concert transducer which has an operating frequency range of 5-200 Hz (The Guitammer Company, Westerville, Ohio 43086).

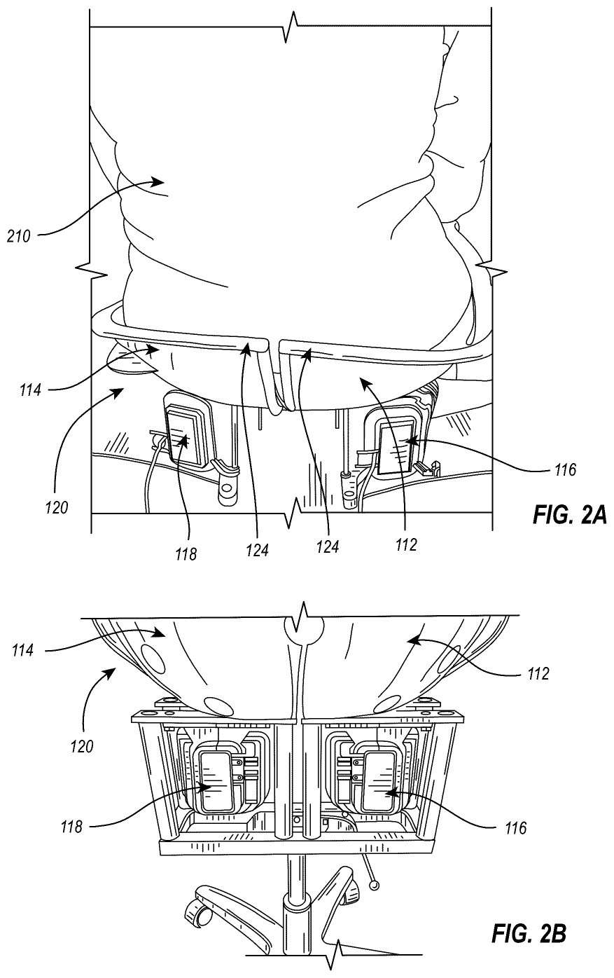

FIG. 2a is a posterior view of a seated subject with transducers positioned to transmit maximal vertical displacement vibration into the pelvis through separately controllable units. A subject 210 sits in the conforming, self-centering seat 120 where the snug shaping of the deep pan seat 120 around her lateral thighs and central spine alignment are apparent. The seat is adjustable to the person's habitus such that the deep pan halves conform snugly to the lateral hip margins. As noted above, the raised surface of the middle portion and the raised edge around the outside of the seat aids in centering and alignment. This customization and seat shape may be important to optimal induction of vibration into the body with associated effects. FIG. 2b shows a further posterior view of the seat which can be adjusted for width as well as tilt angle.

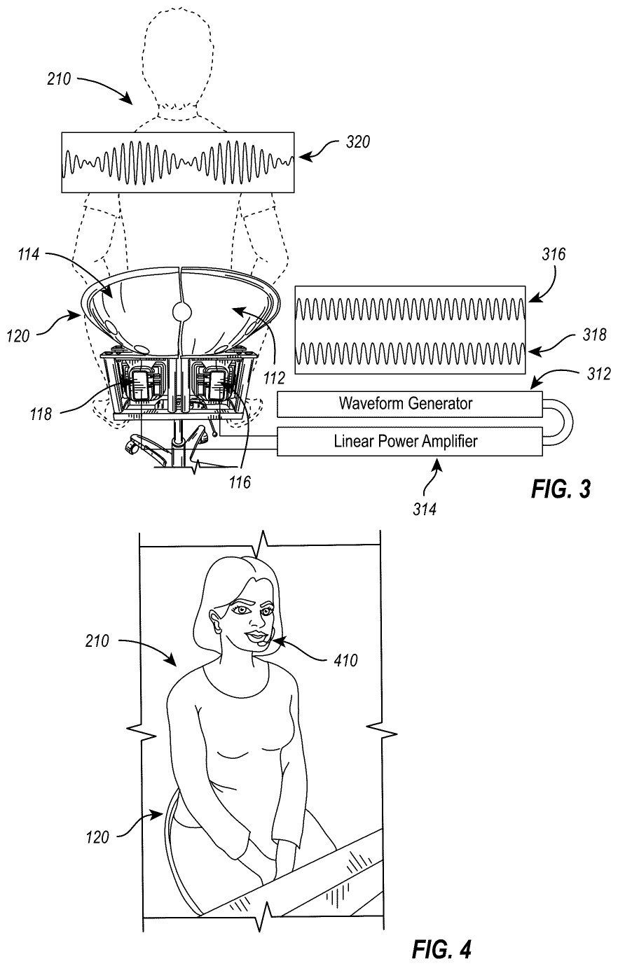

FIG. 3 is a schematic diagram of waveform drive control for each of the two vibration sources through two separate programmable function generators. The waveform for each can be changed from sinusoidal to square or triangle or even uniquely shaped. The output voltage is amplified and applied to the vibration sources such that a maximal induced vibration is about 3 G, but adjustable. Drive frequencies can range between 5 Hz and 250 Hz, but in some implementations more optimally in the range of 15-40 Hz. While sinusoidal waves in the therapeutic range of 45-80 Hz can be induced, in some implementations the more effective method is the employment of square waves in the 15-25 Hz range, resulting in a 3rd harmonic at the 45-80 Hz range induced into the body by each transducer. By offsetting the frequency of the two vibration sources, e.g. 26.7 and 27.7 Hz, a traveling interferential beat frequency pattern is induced at 1 Hz moving up and down the spine. This beat frequency can be adjusted by difference between the two drive frequencies, typically ranging between 0.1 Hz and 10 Hz, in some implementations optimally 0.5 to 2 Hz.

The system shown is configured to drive asymmetric, independent vibration into each half of the seat and the body. Two programmable function generators 312 may control each vibration sources (e.g. 116, 118) independently. The programmable generators 312 can create a first drive signal 316 and a second drive signal 318. The first and second drive signals 316, 318 may be sinusoidal, triangular, a rectangular with variable duty cycle at frequencies, or a customized waveform between 5 and 200 Hz to correlate with the range limits of the vibration sources. The output voltage of the function generators can be adjusted between 0 and 1.5 V, the latter for maximal drive effect. The first and second drive signals 316, 318 may be conditioned (e.g. amplified, strengthened, conditioned, increased in power) by an amplifier 314. Further, the waveform combinations between two simultaneously operating function generators can be sequenced in time to achieve various parameters in the desired frequency range of 45 to 80 Hz. Exemplary function generator may include the Resonant Light Progen II programmable function generators for this purpose (Resonant Light Technology Inc., Courtenay, BC).

Continuing with FIG. 3, the output signal of each programmable function generator passes to stereo inputs of an audio amplifier which accommodates stereo input and outputs. Each signal is amplified in the functional range of 5 Hz to 200 Hz with a maximum of 1500 W out of each channel to each of the two vibration sources. Exemplary amplifiers may include the Behringer NX3000 amplifier for this operating range (Behringer Amplifiers, MusicTribe Inc., Las Vegas, Nev.).

FIG. 3 also shows inductor coil pickup sensors affixed to the cylinder casing of each vibration source. Since the piston is a magnet, the coil faithfully transduces piston movement to a signal for monitoring of the independent stereo drive patterns. The inventors have had success with the Radio Shack telephone pickup coil (Radio Shack 44533, Fort Worth, Tex.). The pickup coils are connected to a multichannel sound amplifier with USB interface for real time plotting and tracking of use of the seat. An exemplary analog to digital converter amplifier may include the Focusrite 18i20 analog-digital converter amplifier combination which interfaces to a PC computer (Focusrite Inc, High Wycombe, Great Britain). The signal may be displayed by software rendering in standard oscilloscope tracings as well as surround sound depiction to capture interferential beat effect traversal in the body. An exemplary software may include the Virtins Multi-instrument software for oscilloscope rendering (Virtins Technology, Singapore) and the MasterPinguin Surround Sound software for surround depiction of the body in a coronal plane (Pinguin Ingineurbuero GmBH, Hamburg, Germany). The signals 316, 318 may be super-imposed in the subject 210 to generate a super-imposed signal 320 (e.g. a beat signal) to simulate the spine of the subject 210.

FIG. 4 is a frontal view of a seated subject. The subject 210 is positioned into the conformal, dual-vibrating seat 120. In the subject's mouth is a customized mouthguard 410 reversibly affixed to the maxilla. The mouthguard 410 may only fit the subject 210. The inventors have had success with the Nike Impact sports mouthguard which includes an extension for attaching a transducer (Nike Inc, Beaverton, Oreg.). This transducer detects transmitted vibrations of the spine, from pelvis to cranium, as induced by the stereo vibration sources. It can be of the piezo or accelerometer type, wired or wireless. The inventors have had success with the Peterson acoustic guitar pickup for this purpose (guitar pickup TP-3, Peterson Electro-Musical Products Inc, Alsip, Ill.). While one implementation may include the sensors (piezo sensors, accelerometers, etc) in a mouth guard, other sensor attachments may be utilized either attached to the subject by adhesive or other wearable, clothing, or harness.

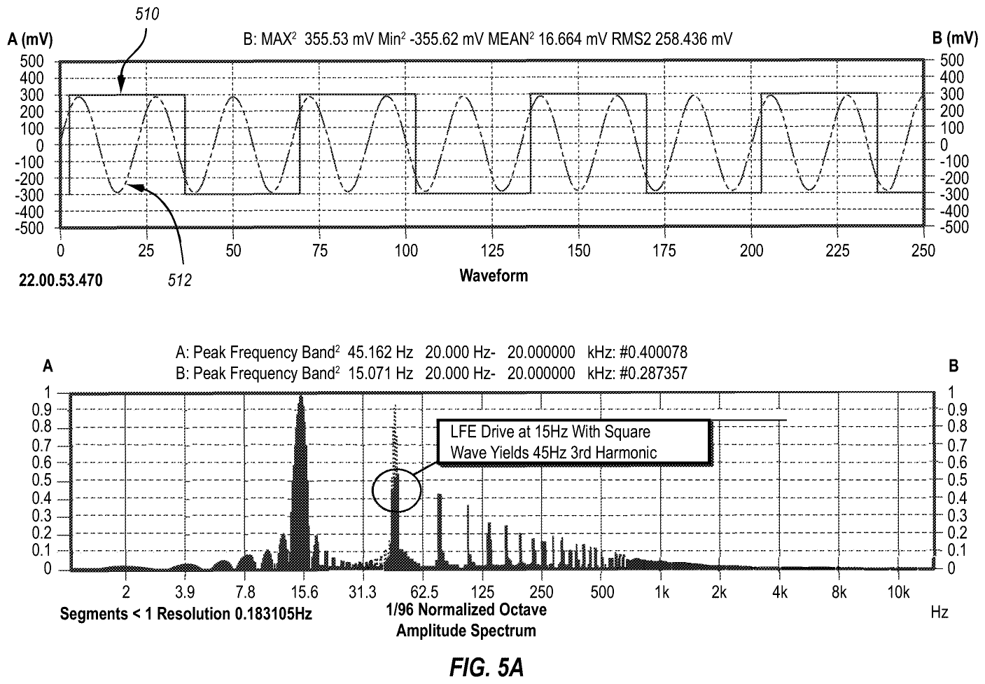

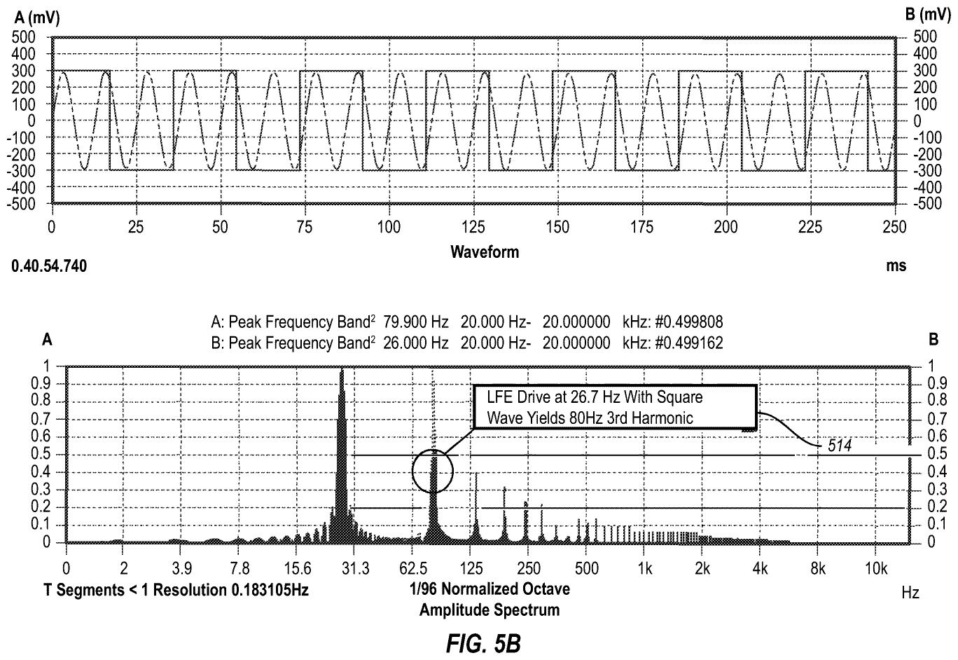

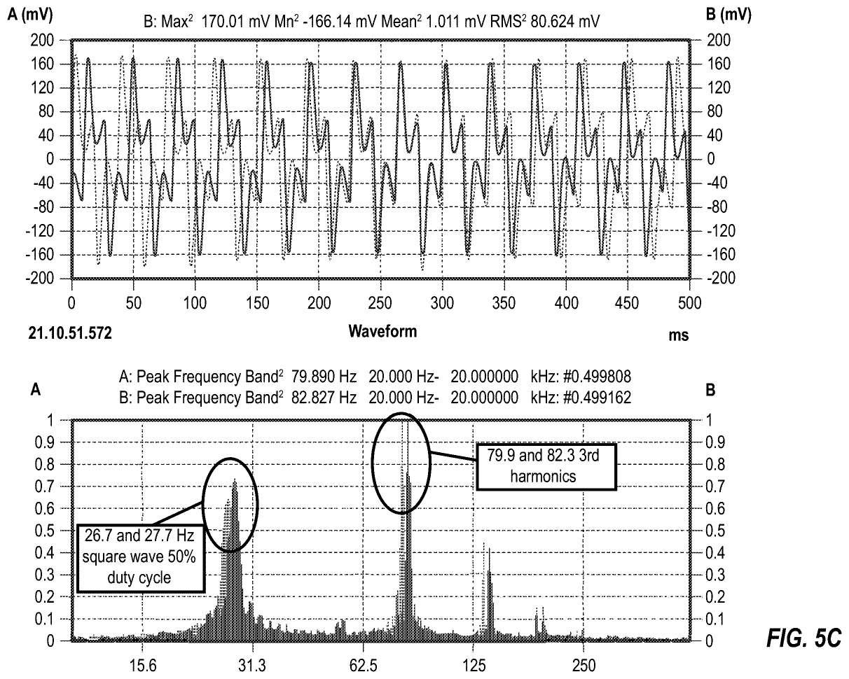

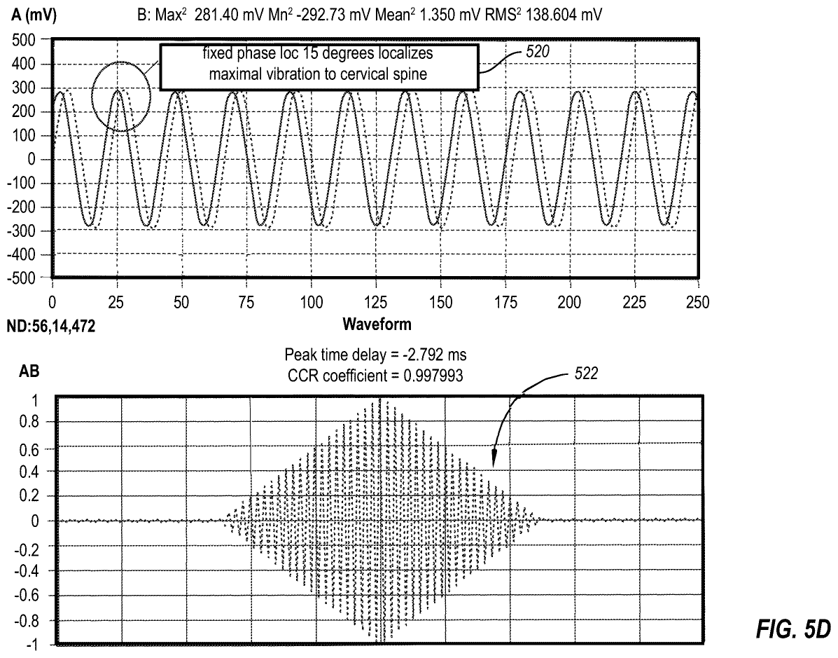

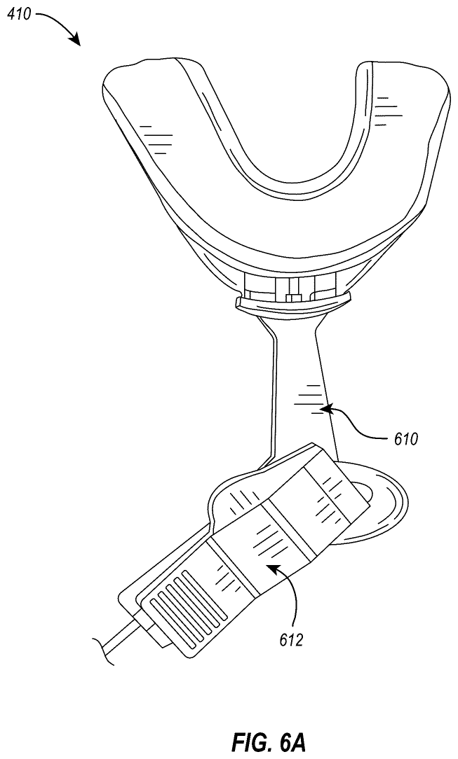

FIG. 5a is a real time plot of inductive coil sensors affixed to each of the transducer units to monitor drive frequency, amplitude, and waveform shape. In this example, the left vibration source is driven by a 50% duty cycle rectangular wave to induce 3 g at 15 Hz and the right vibration source is driven at 15 Hz. The plot further shows the fast Fourier transform (FFT) of each tracing which demonstrates the third harmonic at 45-46 Hz range.

A computer software oscilloscope rendering may be used to illustrate a real time plotting of inductive coil pickup voltages from the stereo vibration sources. While sinusoidal drive in the optimal frequency range of 45-80 Hz range can be easily induced, the effect is weak. An alternative approach has been shown to be more effective. Each vibration source may be driven with a rectangular square wave 510 with 50% duty cycle at a sequenced range between 15 and 26.7 Hz and 16 and 27.7 Hz respectively. Since the square wave is of high quality, the 3rd harmonic of transduced energy may be dominant in a range between 45 and 81 H. The plot in FIG. 5a shows the square wave from each of two channels rendered by the audio amplifier, hence with significant overshoot. The FFT plot shows the optimal 3rd harmonic pattern 512 at 45 Hz.

FIG. 5b shows the same square waveform driven at 26.7 and 27.7 Hz, resulting in the third harmonic 514 induced into the body at 79-81 Hz range. FIG. 5c shows induced frequency in the 45-80 Hz range and may be optimal for relief of symptoms for some implementations.

Driving two stereo amplifiers with an offset frequency, in this instance 1 Hz, results in induced beat frequencies which represent the difference between the two drive frequencies. For example, 26.7 Hz in channel A and 27.7 Hz in channel B induces a sinusoidal 1 Hz beat frequency which consists of the two fundamental drive signals swelling and collapsing in a repeating pattern. When the two signals are fully out of phase, the subject experiences transverse oscillation of the hips in the conformal seat. When the two signals are fully in phase, the subject experiences vertical oscillation and vibration extending into the cervical spine and head. In transition between phases at the beat frequency, the subject experiences a vertical traversing wave with a maximum which can be phase-locked. For example, if maximal cervico-thoracic vibration is desirable, locking of the phase relationship 520 to 15 degrees achieves this. The super-imposed waveform produced 522 is shown in plot 5 d. FIG. 5d shows a phase lock between the two drive frequencies at 15 degrees, resulting in a fixed and nontraveling subjective vibration in the cervico-thoracic spine region.

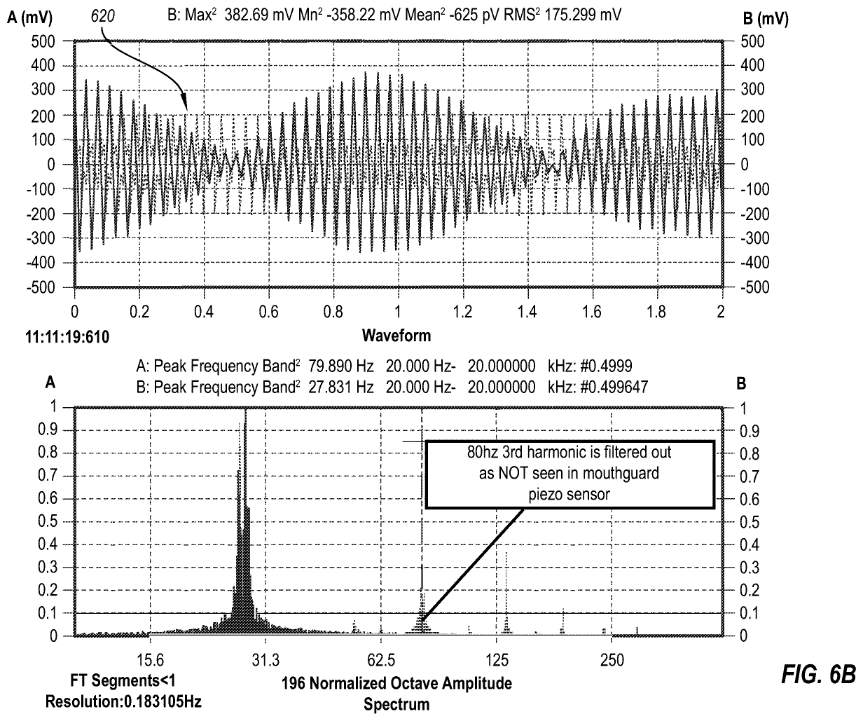

FIG. 6a shows a customized mouth guard integrating a piezo vibration sensor. The mouth guard affixes to the subject's maxillary teeth print, enabling transduction of induced vibration and beat frequencies into the cranium. A close-up of the customized mouthguard 410 with integrated piezo sensor is provided. The mouthguard 410 can be individualized to fit snugly to the maxillary teeth. It includes a stem 610 beyond the lips where sensor 612 (e.g. a piezo sensor or an accelerometer sensor) is affixed. The sensor may capture the qualitative amplitude of induced frequencies in the body at their drive frequency from the vibration sources. More particularly, it may capture the interferential beat frequency which is perceived to ascend up the spine from the pelvis to cranium. For example, if the two vibration sources are driven at 26.7 and 27.7 Hz, a 1 beat difference interferential beat effect is induced with twice the amplitude of the driving waveforms at peak and zero and lowest point. Additional sensor types can be affixed to the body or engaged by the body to transduce the effect of induced vibration into the body, including piezo, accelerometer and force transducers.

FIG. 6b is a real time plot of the vibrational sensor from the mouth guard which quantifies the emergence and subsidence of amplitude of the traveling beat frequency as it moves from pelvis to cranium, varying between near zero and 2×full amplitude of either vibration source. The waveform 620 is derived from the mouth guard sensor as amplified through the A/D USB interface and plotted with the oscilloscope software. As such, this mouth guard data can memorialize (e.g. store in memory) a treatment session. For example, if the subject resorts to the stereo vibration seat to gain control over anxiety for a 10 minute session, the datalogging from this sensor demonstrates the engagement of the subject with the system. It becomes a measure of compliance with a regimen to treat withdrawal.

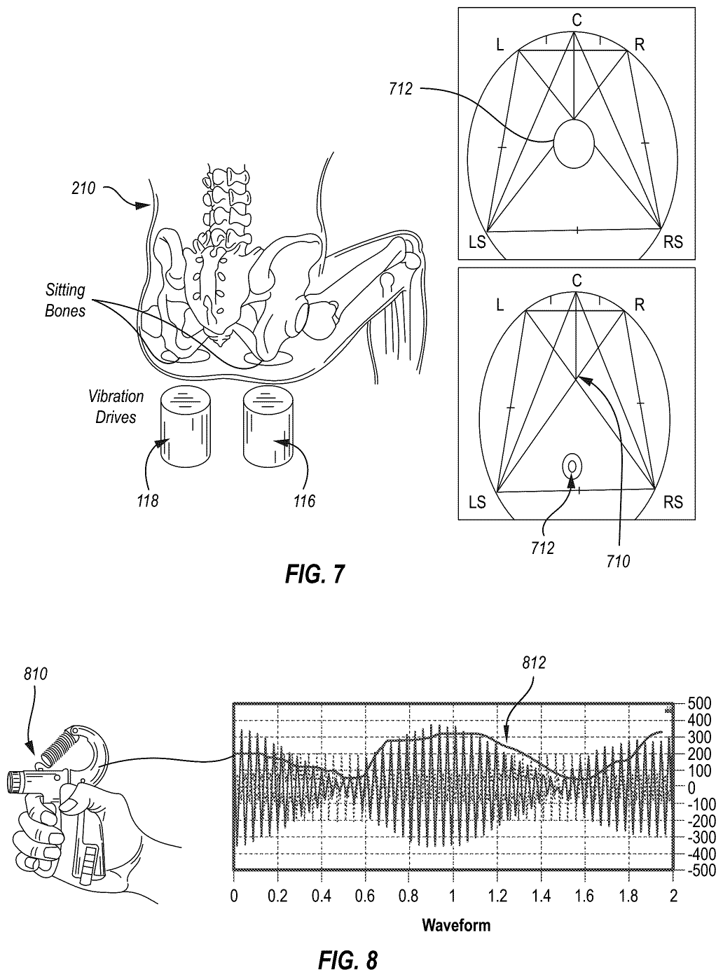

FIG. 7 is a real time plot of drive sensors against the mouth guard vibrational sensor. The depiction is in the coronal plane of the body where the ball 712 moves up and down the spine as the two vibration sources traverse from fully in phase to fully out of phase. Out of phase is perceived as bilateral transverse oscillation of the hips whereas in phase is perceived as vertical oscillation, maximally in the high cervical spine and cranium. The ball size represents amplitude and ball position represents the maxima of induced vibration in the spine.

A software rendering of a surround sound format is employed to depict the location of the maximal vibration as it traverses the spine from pelvis to cranium. Surround sound software allows 3 or more sources of sound in the auditory and infrasonic range to be depicted as a function of independently controlled or measured amplitude and phase. In this instance, the coronal plane of the body is portrayed as rendered in FIG. 1a. The vertex or center location 710 of the graph represents the head or mouthguard sensor and the left posterior 8 μm and right posterior 4 pm positions represent the pickup coil sensors for the left and right vibration sources respectively. As the two drive frequencies differ by a beat frequency offset, for example, 26.7 Hz and 27.7 Hz, the phase of the drive frequencies shifts between fully in phase and fully out of phase at that beat frequency rate, for example, here at 1 Hz. The ball 712 in the graph enlarges with amplitude and the position between pelvis vibration sensors at out of phase and to cranium at fully in phase correlates with the subjective perception of the traveling vibrational maximum. The programmable function generators, as described in FIG. 3 can be set to progress through a sequence of varying drive frequencies and beat frequencies. Subjectively, this is valuable as the person in withdrawal may perceive the spine-traversing vibration as relaxing with slow beat frequencies, e.g., 0.1-0.5 Hz, to alerting or stimulating, e.g., 2-3 Hz and above. Yet further, the phase relationship between vibration source drive frequencies can be locked, e.g. held without change, resulting in a perception of a static traversing vibrational wave at a selected spine level. Fully in a locked in phase, maximal vibration is located at the head and cervical spine region with no beat frequency component. Fully out of phase 180 degrees and locked, the subject perceives a transverse oscillation at the level of the hips or pelvis, again with no beat component.

FIG. 8 is a plot of a subject's mouth guard vibrational sensor showing beat frequencies as depicted in FIG. 6. The plot also illustrates the subject's volitional squeeze of a piezo force sensor to track and emulate the peaks and valleys of the induced beat frequencies. The achieved similarity in amplitude waveforms can be quantified or scored by statistical cross-correlation in real time. The piezo force sensor provides a method of further focused engagement of the subject due to interaction with the beat frequency pattern. As shown in FIG. 6b, the mouthguard transducer tracks the induced beat frequencies. The subject can be given a force transducer 810, which he can actuate with pressure, for example, a hand grip sensor rendering grip compressional strength. The subject can quickly learn through focus to emulate the rise and fall of the beat frequency tracing by squeezing proportional to the sensed and visually rendered beat wave 812. This exercise is highly mentally and physically engaging, depending on the required frequency of emulation tracking and required strength. While aside from the principle interests of this patent, repeated grip compression has been showing beneficial in the nonpharmacologic approach to anxiety and to elevated blood pressure or hypertension (Jorgensen et al., 2018). The inventors have had success with the Vernier Hand Dynamometer (Vernier Software and Technology Inc, Beaverton, Oreg.). The force transducer may be attached elsewhere in the body to track volitional compression which attempts to match the beat frequency minimum to maximum in an interval and isometric exercise including sphincter transducers. Similarly, pelvic floor strength can be substantially enhanced in the treatment of stress incontinence by such repeat exercises tightening on a vaginal-based force transducer (ref Ko et al). One exemplary force transducer includes the Elvie vaginal wireless pressure transducer, (Elvie Inc, London, England). These methods of interval isometric training are thus easily integrated to enhance the therapeutic session on the dual vibration seat and the associated diversional focus also appears therapeutic against anxiety. The figure shows the cumulative tracking of the waveforms using the same oscilloscopic software rendering as described in FIG. 5. A real time cross correlation score of the similarity of waveforms can rank an individual's performance.

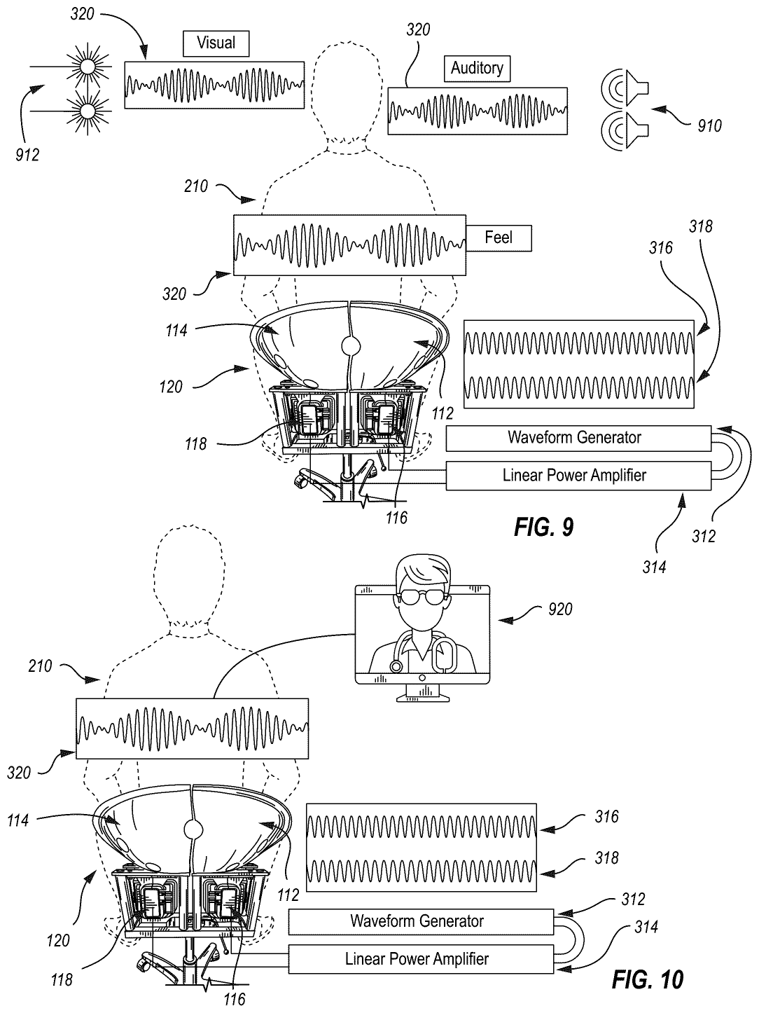

FIG. 9 is a schematic diagram similar to that seen in FIG. 3, but the tactile mechanoreceptor input into the body has been augmented to include auditory pulse input and visual pulse input. Dual auditory, visual, and sensory input may be provided from the same programmable frequency generators, which allows synchronous stimulation of the central nervous system as well as the differential beat effect, which is achieved in the driving of separate seat halves. For example, synchronous bilateral or stereo visual and synchronous bilateral or stereo auditory stimulation may be provided.

In FIG. 9, two additional and separate stereo sensory modalities are shown to provide frequency input into the subject's central nervous system beyond the tactile mechanoreceptor input. Programmable frequency generators also drive speakers 910 to generate auditory pulse data in stereo channels left and right at offset frequencies to achieve beat frequency effect. Yet further, the programmable frequency generators may also drive one or more lights 912 (e.g., lasers, LEDs, or other lighting sources) to generate synchronized light pulsing. While this could be easily deployed as an array of light emitting diodes in single or multiple colors, the inventors have had success with amplitude modulation at those drive frequencies of radio frequency excited plasma tubes in both the argon and neon light spectra (argon pulsed electromagnetic field emissions from Resonant Light PERL system, Resonant Light LLC, Courtenay, BC and the neon pulsed electromagnetic field emissions from Frontier Devices LLC, Pelham, Ala.).

FIG. 10 is a schematic diagram illustrating remote monitoring of the therapeutic session which may include duration of use as an indicator of compliance to a treatment regimen. Remote monitoring of the data from the method described in FIGS. 6 and 7 may be provided. It is anticipated that the dual vibrational seat system will be availed most efficaciously in the home environment or in an acute detoxification environment. Documentation of use and compliance with a treatment regimen are essential in this patient population where the re-emergence of drug-seeking behavior is a high risk. The addiction specialist can thus engage through well-established means of telemedicine to optimize chances for successful bridging through the anxiety associated with withdrawal craving. The subject may communicate with a professional through a telecommunication system 920, which may provide video conferencing communication and may transmit measured and generated waveform data from the system to the professional for further analysis and verification. The system may allow the professional to remotely program the parameters for future treatments based on analysis and consultation with the patient. The parameters may be stored as files or within a database 924 connected to the waveform generators. The files or database parameters may be accessed by a controller 922 and scheduled to run on the waveform generator either at the next session, periodically, or on demand. The controller may access, plan, and execute a sequence of waveform parameters to produce a sequence of different perceived waveforms inside the patient. (e.g. sequential traveling beat patterns and/or stationary patterns with different frequencies, intensities, etc. over a period of time).

Alternatively, the professional can access the parameters in real time and adjust the parameters while simultaneously monitoring the treatment of the subject. The information recorded for each session may include vibration patterns, duration, and exercises. Additionally, the data collected regarding the vibration parameters may be integrated with other locally transduced or measured sensors known to respond to anxiety or withdrawal including heart rate, blood pressure, heart rate variability, skin DC resistance or impedance, or pupillary size and reactivity. These additional, measurements may be presented with the vibration measurements and may be used to manually or automatically adjust the vibration parameters (e.g. frequency, amplitude, phase, duration and waveform) for the waveform generators.

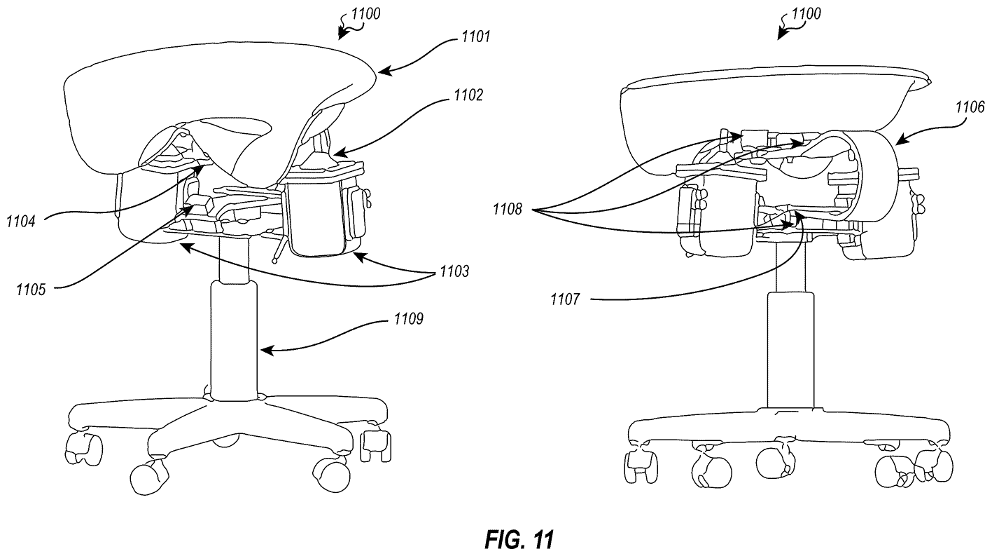

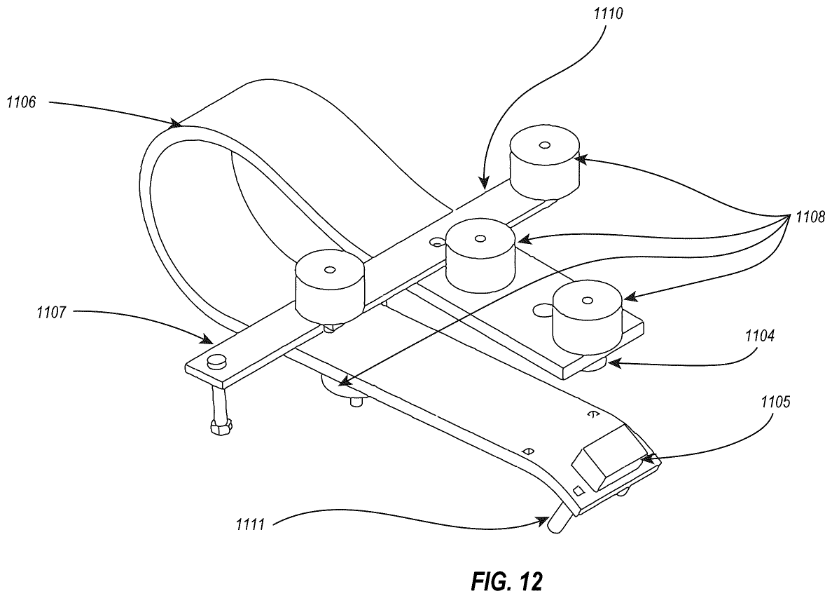

Reference is now made to FIGS. 11 and 12, which illustrate an alternative embodiment. FIG. 11 illustrates a therapeutic device 1100. The therapeutic device 1100 includes a seat 1101. In this example, the seat 1101 is a deep pan tractor seat as illustrated previously, but in this example the seat 1101 is monolithic in construction and not split, and thus is a unified seat. The therapeutic device further includes vibrator mounting brackets 1102 to mount the vibrators 1103, similar to vibration sources 116 and 118. The transducers may sit at an elevated height off the floor for a subject's normal seat height. The vibrators 1103 can induce vibration in a patient by the impulse movement of a vertically oriented magnetic piston, as previously described. In the case of therapeutic device 1100, the vibrators 1103 can be in mechanical communication with unified seat 1101, similar to the above-described embodiments. One vibrator 1103 can communicate mechanically with the non-separated sagittal half of the unified seat in such a case.

In some embodiments, the therapeutic device 1100 further includes a magnet 1104 (which may be a neodymium magnet) and a hall effect sensor 1105. The hall effect sensor 1105 may be implemented in some embodiments by using a bass guitar pickup. In some embodiments, as a patient sits on seat 1101, the patient may lean forward on seat 1101, causing the magnet 1104 to move closer to the hall effect sensor 1105. The closer the magnet 1104 is to the hall effect sensor 1105, the stronger a signal will be generated by the hall effect sensor 1105. The signal generated by the hall effect sensor 1105 may be provided to control the one or more programmable function generators to generate additional frequencies or modify the frequencies to be provided to the amplifiers to control the vibrators 1103.

FIG. 11 further illustrates an open-ended suspension 1106, or c-spring, which allows the patient to cause the magnet 1104 to move closer to the hall effect sensor 1105 based on the weight of the patient and the orientation of the patient's body relative to the therapeutic device 1100. FIG. 11 illustrates a spring clamp 1107 for securing the open-ended suspension 1106 to a base 1109. Base 1109 can comprise one or more of leg(s), wheel(s), feet/foot, hydraulics, swivel(s), etc. FIG. 11 further illustrates vibration isolators 1108, which in some embodiments are constructed of neoprene, to isolate seat 1101 from the open-ended suspension 1106. FIG. 12 illustrates a stabilizing bar 1110. FIG. 12 also illustrates an angled stand-off 1111 for securing the open-ended suspension to the base 1109. In a given embodiment, a therapeutic device can comprise a different suspension system, that is not an open-ended suspension. For example, a manufacturer can install one or more vertical springs that couple to the unified seat.

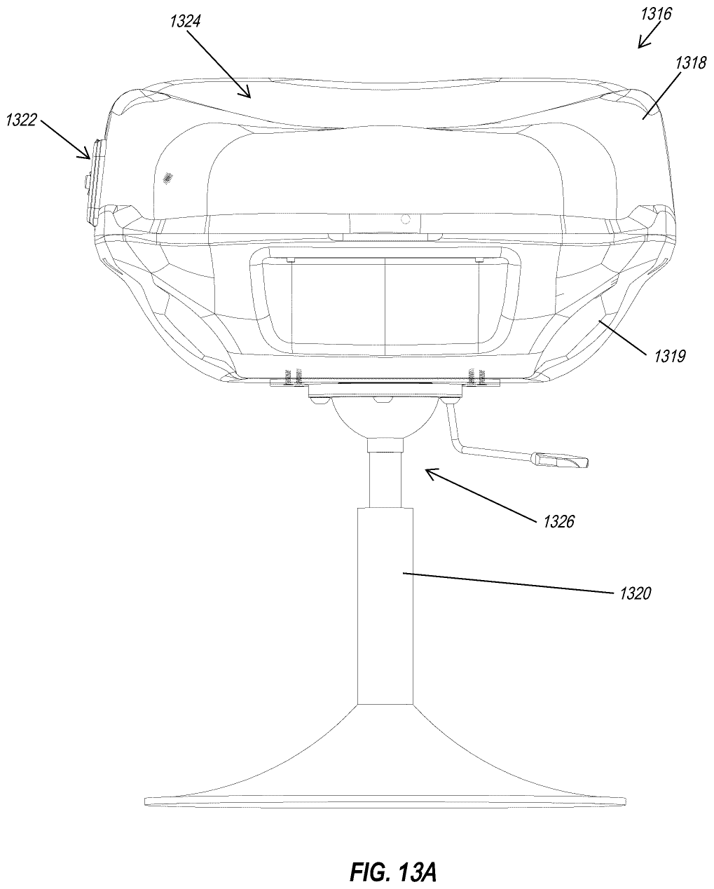

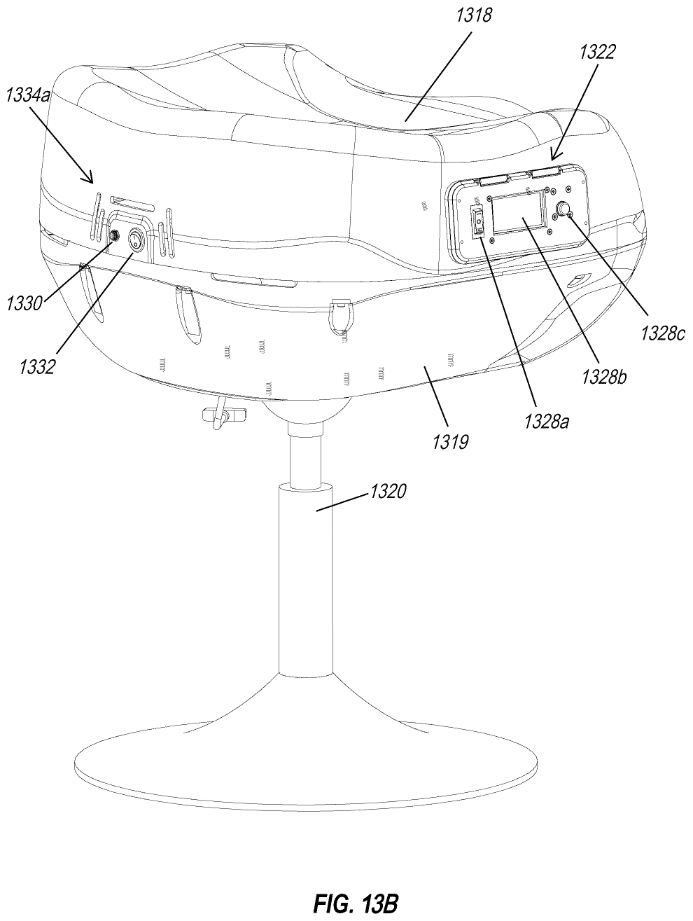

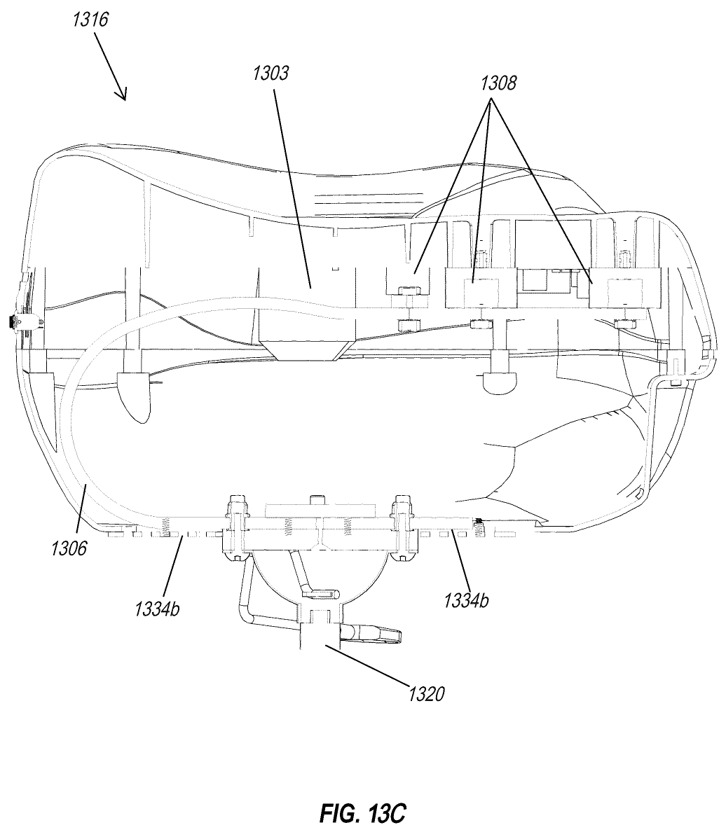

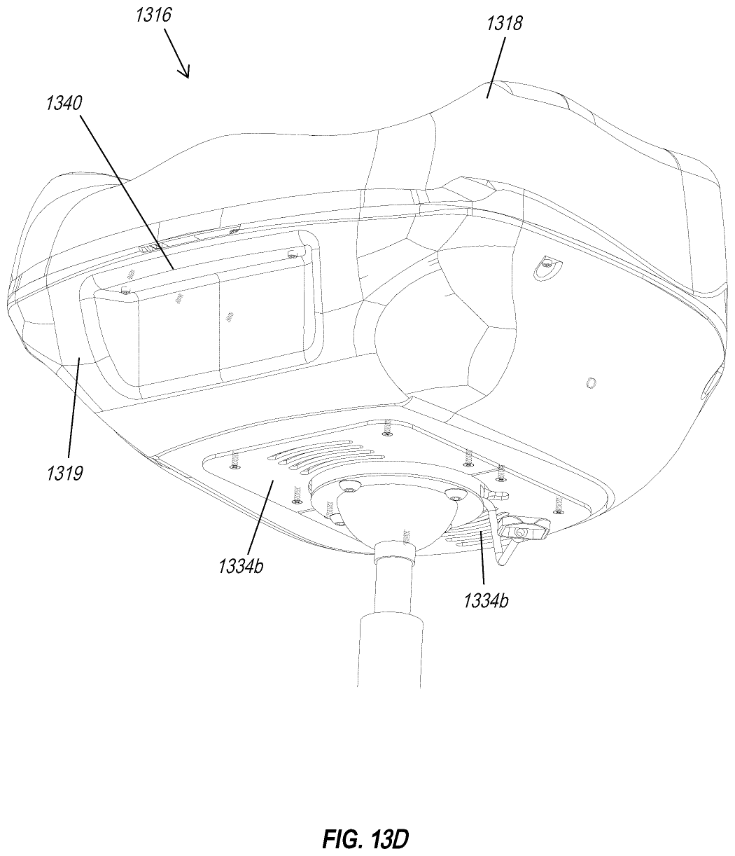

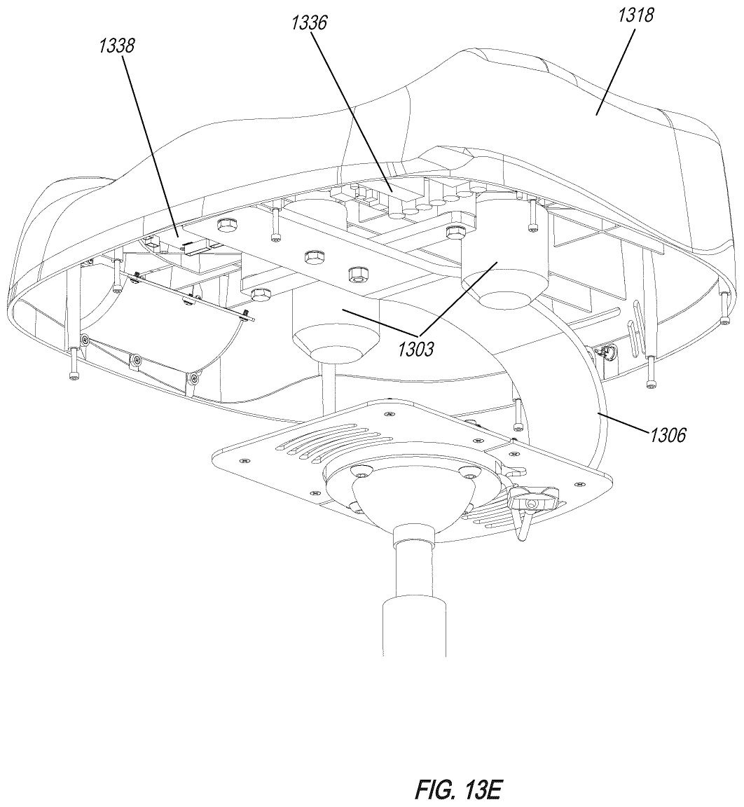

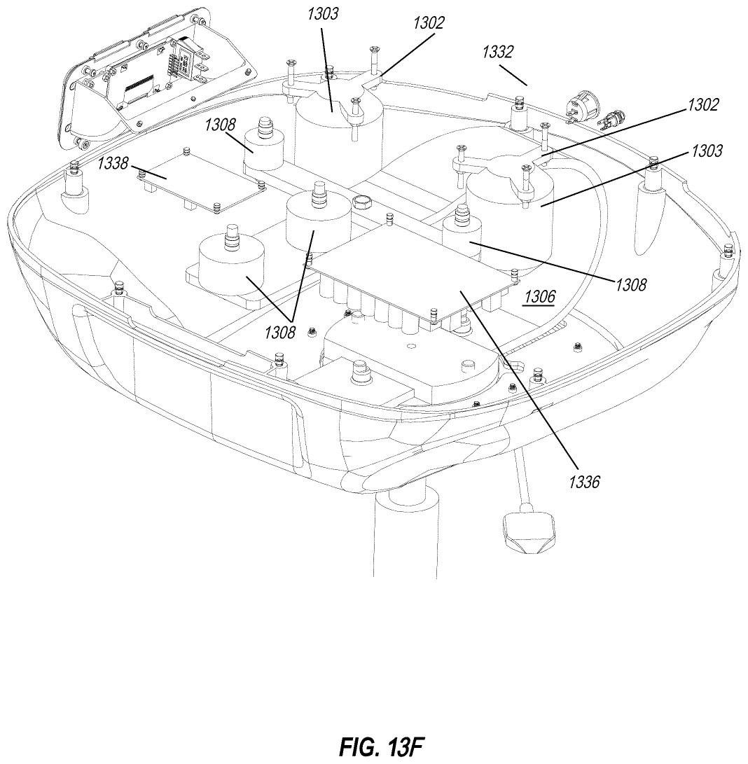

FIGS. 13A-13F illustrate a therapeutic device 1316 of the present disclosure sharing many qualities with therapeutic device 1100. FIG. 13A illustrates a front-view perspective of therapeutic device 1316, which has a top shell 1318 and a bottom shell 1319, wherein an aesthetic covering can be custom-fitted to surround the internal components. The internal components of therapeutic device 1316 can include a unified seat (illustrated as top shell 1318), at least two vibrators 1303, an open-ended suspension 1306 (or an alternative suspension system such as one or more vertical springs), a hall effect sensor (not shown), a magnet (not shown), mounting brackets 1302, an amplifier, a control board, and vibration isolators. An aesthetic covering (not shown) can be constructed from one or more of leather, faux leather, vinyl, fabric, polyester, microfiber, velvet, suede, mesh, or the like. A manufacturer can also include a foam or cushion layer (not shown) between the internal components of the therapeutic device 1316 and the aesthetic covering. In at least one embodiment, a manufacturer can not install a suspension system.

The unified seat or top shell 1318 can include a contour 1324 or an ergonomic design similar to the embodiments described above that is defined by the shape of top shell 1318. Contour 1324 enables a user to sit more comfortably on therapeutic device 1316 while also enabling therapeutic device 1316 to transfer vibrations into the patient's body, achieving a traveling wave in a more efficient manner. In at least one embodiment, contour 1324 is configured with curves that conform specifically to a patient's body, ensuring comfort while providing a firm, secure connection between the patient and the therapeutic device to maximize the efficient transfer of vibrations. Contour's 1324 shape supports natural body alignment, reduces pressure points, aids in upright seating, and enhances stability and comfort during use.

Top shell 1318 is a rigid molded or formed member configured to support a user and is coupled to internal components, such as the two vibrators, an amplifier, and a control board. Top shell 1318 is also in communication with the open-ended suspension 1306 by way of the vibration isolators 1308. Top shell 1318 is also selectively coupled with bottom shell 1319 through several fasteners. In at least one embodiment, the connection between top shell 1318 and bottom shell 1319 comprises a flexible coupling mechanism that allows for limited movement or “give” between the top and bottom shell, permitting slight separation while maintaining functional engagement. In at least one embodiment, top shell 1318 or the unified seat of a therapeutic device can be a part of the open-ended suspension.

Bottom shell 1319 is configured to be selectively coupled to the top shell 1318 and the base 1320. Bottom shell 1319 is further coupled to vents 1334b as well as the lower portion of the open-ended suspension 1306. Bottom shell 1319 is also a rigid formed or molded member. Bottom shell 1319 further comprises a lip 1340 which is defined by the molded or formed shape of bottom shell 1319. Lip 1340 is configured to enable a user to grip therapeutic device 1316 and lift or move it. Lip 1340 may also be used by a user during their use of therapeutic device 1316 to help them align themselves properly on top shell 1318.

Base 1320 can have a flanged or flared lower section that provides stability for a patient sitting on the therapeutic device 1316. On the bottom side of the flanged or flared lower section, a manufacturer can install grip elements that enable the base 1320 to not slide or slip on slick surfaces. Base 1320 can further include a bearing or means for rotation at one end or along its shaft. For example, the flanged or flared lower section can have a bearing coupled to a gripped surface configured to allow the base 1320 to rotate relative to the gripped surface. In another embodiment, a bearing or rotational means can be coupled or embedded to the base 1320 where base 1320 interfaces with bottom shell 1319. In such a case, the bearing can be configured to couple to the open-ended suspension or unified seat, allowing the open-ended suspension and unified seat to rotate relative to base 1320.

Base 1320 further comprises a lifting and lowering piston, lift mechanism 1326. A lever can operate lift mechanism 1326, enabling users to raise or lower therapeutic device 1316 to adjust for their personal height or preferences.

Therapeutic device 1316 can further comprise interface 1322. FIG. 13B better illustrates interface 1322. Interface 1322 can include control means such as push buttons, toggle switches, rocker switches, momentary switches, membrane switches, rotary dials, touchscreens, or the like. As illustrated, interface 1322 can comprise switch 1328a, screen 1328b, and dial 1328c. Interface 1322 can allow a patient to turn on or off the therapeutic device, control or monitor the frequency or vibration levels of the vibrators embedded inside therapeutic device 1316, activate pre-programmed vibration present or program vibration presets, adjust the volume of an optional speaker, or to interface with an on-board computer or database directly. Therapeutic device 1316 further comprises port 1330, can be configured for power and/or data transfer, and switch 1332, can be configured to fully power on or off therapeutic device 1316. As illustrated, port 1330 and switch 1332 can be coupled to the rear face of top shell 1318. Additionally, vents 1334a are configured to allow for the introduction or exfiltration of air or heat within therapeutic device 1316.

Therapeutic device 1316 can have a battery or set of batteries (not shown) to power vibrators 1303 and other electronic components that enable users to use the therapeutic device in a self-contained manner. In one embodiment, a power cord can be electronically connected to the electrical components of therapeutic device 1316 to allow for the charging of the optional batteries or to power the electrical components from an outside power source directly.

FIG. 13C illustrates a side cross-sectional view of therapeutic device 1316. As shown, open-ended suspension 1306 (or an alternative suspension system such as vertical springs, leaf springs, hydraulics or pneumatics, torsion springs, or similar suspension means) is configured to couple to base 1320, top shell 1318, bottom shell 1319, and a plurality of isolators 1308. As previously disclosed, in at least one embodiment, open-ended suspension can be coupled to a magnet (not shown) that is in magnetic communication with a hall effect sensor (not shown). Open-ended suspension is configured to carry a user's weight of therapeutic device 1316 and ensure that the vibrations created by vibrators 1303 are not fully or partially propagated into base 1320.

FIG. 13D illustrates a perspective view of the bottom of therapeutic device 1316. As illustrated, bottom shell 1319 further can comprise vents 1334b, which are configured to allow the transfer of heat and air from inside therapeutic device 1316. A user will appreciate both vents 1334b and 1334a as they facilitate heat dissipation and air circulation, preventing overheating and moisture buildup, which enhances the performance and longevity of their therapeutic device while also allowing the therapeutic device to maintain an aesthetic and unsuspecting profile, allowing a user to place their therapeutic device in any room. In at least one embodiment therapeutic device 1316 further comprises a fan to facilitate air flow.

FIG. 13E illustrates the same perspective view of the bottom of therapeutic device 1316 as shown in FIG. 13D. However, bottom shell 1319 has been made transparent to better illustrate the inner components of the therapeutic device 1316 and their interconnections. Vibrators 1303 can be seen coupled directly to top shell 1318. Additionally, amplifier 1336 and control board 1338 can be seen secured to the bottom surface of top shell 1318. As previously discussed, amplifiers such as amplifier 1336 can be configured to amplify one or more signals transmitted to the vibrators 1303 in the functional range of 5 Hz to 200 Hz with a maximum of 1500 W out of each channel to each of the vibrators. In any embodiment, an amplifier can take a lower power input signal, for example, from the control board 1338, and create a higher energy-capable signal to drive or power the vibrators.

Control board 1338 can comprise a piezoelectric sensor, an accelerometer, a microphone, a gyroscope, or a similar sensor that can be used to measure and track the vibrations imparted by the vibrators 1303. Control board 1338 can further comprise a processor, memory, RAM/ROM, a Wi-Fi or Bluetooth module, and connections for each of the electronic components of the therapeutic device 1316. In such an embodiment, a user can communicably couple a phone, computer, tablet, or similar personal computer device to control therapeutic device 1316 by port 1330 or over Wi-Fi or Bluetooth.

FIG. 13F illustrates a similar perspective view of the bottom of therapeutic device 1316. However, top shell 1318 has been made transparent to illustrate better the interconnection of elements of therapeutic device 1316 with bottom shell 1319. As illustrated, open-ended suspension 1306 and vibration isolators 1308 are configured to isolate bottom shell 1319 and base 1320 from the vibrations created by vibrator 1303. As such, vibrators are only coupled directly to top shell 1318 by way of mounting brackets 1302. Vibration isolators 1308 can have varying diameters and thicknesses configured to limit the vibrations propagated into the open-ended suspension 1306 from vibrators 1303.

In one embodiment, alternatively or additionally to the embodiments described above, a patient or user may be able to hum into a transducer, such as a microphone. The frequency at which the patient hums into the transducer may be used to control the programable function generators to increase the magnitude of signals produced by the vibrators 1103 or 1303. For example, a higher frequency may cause the vibrators 1103 or 1303 to stimulate the therapeutic device with more force as compared to a lower frequency. Alternatively, a lower frequency may cause the vibrators 1303 to stimulate the therapeutic device with more force as compared to a higher frequency. The transducer can be communicably coupled to the control board 1338 of the therapeutic devices in a wired or wireless configuration.

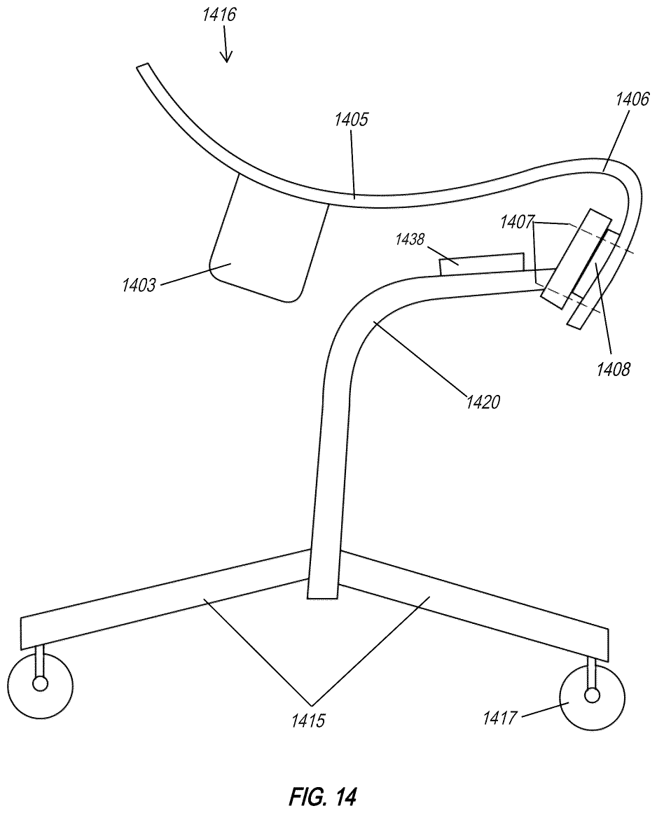

FIG. 14 illustrates a cross-sectional view of therapeutic device 1416 of the present disclosure. Therapeutic device 1416 can comprise one or more vibrators 1403, an open-ended suspension 1406, such as c-spring suspension, vibration isolator 1408, control board 1438, base 1420, and one or more legs 1415. The open-ended suspension 1406 can comprise or be attached to a seat in certain embodiments. For example, a manufacturer can upholster or secure a seat to the curved portion 1405 of therapeutic devices 1416, or a patient can sit directly on the curved portion 1405. Curved portion 1405 can be more or less curved in a given embodiment than what is illustrated in FIG. 14. Curved portion 1405 can have an overall ergonomic shape. Open-ended suspension 1406 can support a patient in a cantilever style. A manufacturer can construct open-ended suspension 1406 so that when a patient sits on a therapeutic device 1416, vibrators 1403 are oriented horizontally, and the patient can sit straight up and down (or upright). For example, curved portion 1405 can be elevated such that when a patient sits on curved portion 1405, it does not drop beyond a horizontal orientation. In one embodiment, a patient sitting on curved portion 1405 can bend open-ended suspension 1406 about 10 degrees to about 20 degrees. Open-ended suspension 1406 can be constructed from 0.375-inch aluminum and can provide support for a weight of about 500 pounds.

Though not seen in FIG. 14, one or more open-ended suspensions 1406 can be installed by a manufacturer. For example, two open-ended suspensions 1406 can be installed such that they are positioned parallel to each other. In such an example, a manufacturer can couple or unify the curved portion 1405 of each open-ended suspension together to form a seat. A manufacturer may unify one or more open-ended suspension 1406 where they secure to the base 1420.

FIG. 14 shows base 1420, which a manufacturer can construct from one or more segments of tubing or material. In one embodiment, base 1420 can be constructed from 4 to 6 inch steel tubing. Vibration isolator 1408 can be a foam, rubber, or similar vibration-mitigating material. For example, a manufacturer can use a recycled rubber or plastic material that is durable and shock absorbing, such as the rubber flooring found in a gym. A manufacturer can install about 0.25 inches to about 2 inches or more of the material as a vibration isolator 1408. One or more fasteners 1407 can secure base 1420 to both the one or more vibration isolator 1408 and the one or more open-ended suspensions 1405. For example, fasteners can be perforated metal strapping that wraps around the components, screws or bolts that pass through the components, or any other similar fastening means.

Control board 1438 can comprise one or more amplifiers, controllers, communication modules, sensors, and similar electronic components. Control board 1438 can perform similar tasks to the control boards and amplifiers previously disclosed. In at least one embodiment, no control board is installed, and instead, a manufacturer includes a port wherein a user or patient can plug an amplifier and control into therapeutic device 1416.

FIG. 14 shows the one or more transducers 1403 secured to the open-ended suspension 1406 at or near the curved portion 1405. A manufacturer can secure transducers 1403 with bolts or screws through the open-ended suspension or into threaded holes disposed along the open-ended suspension.

FIG. 14 also shows that therapeutic device 1416 can comprise one or more legs 1415. For example, a manufacturer can install 3, 4, 5, or 6 legs in a given embodiment. A leg 1415 can have a foot or lockable wheel 1417 attached.

Modifications to these embodiments by use of alternative transducer and sensor types, methods of subject positioning for optimal engagement of peripheral sensorimotor mechanoreceptor circuits, data gathering and analysis, and co-registration with other biomarkers of anxiety may be familiar to those skilled in the diagnostic and therapeutic science and art of management of withdrawal. All are within the spirit and scope of these claims.

The following discussion is intended to provide a brief, general description of a suitable computing environment in which the present disclosure may be implemented. Although not required, the present disclosure will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the present disclosure may be practiced in network computing environments with many types of computer system configurations, including personal computers, hand-held devices, multi-processor systems, microprocessor-based or programmable consumer electronics, network PCs, minicomputers, mainframe computers, and the like. The present disclosure may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

The present disclosure may comprise or utilize a special-purpose or general-purpose computer system that includes computer hardware, such as, for example, a processor and system memory, as discussed in greater detail below. The scope of the present disclosure also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the present disclosure can comprise two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the present disclosure.

Transmission media can include a network and/or data links which can be used to carry program code in the form of computer-executable instructions or data structures, and which can be accessed by a general-purpose or special-purpose computer system. A “network” is defined as data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module, and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the present disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the present disclosure may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes a host that is capable of running virtual machines. During operation, virtual machines emulate an operational computing system, supporting an operating system and perhaps other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine interfaces with the appearance (e.g., a virtual resource) of a physical resource. Examples of physical resources including processing capacity, memory, disk space, network bandwidth, media drives, and so forth.

The present disclosure may be embodied in other specific forms without departing from its spirit or essential characteristics. The described examples are to be considered in all respects only as illustrative and not restrictive. The scope of the present disclosure is, therefore, indicated by the appended claims rather than by the foregoing description. All changes which come within the meaning and range of equivalency of the claims are to be embraced within their scope.

We claim:

1. A therapeutic device comprising:
a unified seat wherein the unified seat is monolithic in construction and configured for supporting a patient and for transferring vibration into a patient's body;
a suspension system between the unified seat and a base;
a first vibrator transducer connected to a first portion of the unified seat and configured to cause a first vibration to propagate from the first portion of the unified seat; and
a second vibrator connected to a second portion of the unified seat and configured to cause a second vibration to propagate from the second portion of the unified seat, the second vibration having a different frequency than the first vibration, wherein a resulting interference comprises a low frequency traveling wave that propagates from the unified seat to the patient's head.

2. The therapeutic device of claim 1, wherein the base is vibrationally isolated from the suspension system and the unified seat.

3. The therapeutic device of claim 1, further comprising a transducer configured to determine an amount that the patient leans forward on the unified seat so as to cause the first and second vibrators to produce an additional or a different frequency.

4. The therapeutic device of claim 1, further comprising a transducer configured to determine a frequency at which the patient hums into the transducer so as to cause the first and second vibrators to produce an additional or a different frequency.

5. The therapeutic device of claim 1, wherein the suspension is an open-ended suspension configured to support the patient in a cantilever style.

6. The therapeutic device of claim 1, further comprising a sensor in mechanical contact with the patient's head to measure one or more harmonic frequencies observed in the patient's head.

7. The therapeutic device of claim 6, wherein the sensor is configured to provide a feedback signal to at least one of the first or second vibrators in response to the traveling wave.

8. The therapeutic device of claim 6, wherein the sensor comprises a mouth guard sensor integrated into a mouth guard to measure one or more harmonic frequencies, wherein the mouth guard is customized to a maxillary tooth print pattern of the patient.

9. The therapeutic device of claim 1, further comprising an interface configured to enable the patient to interact with the therapeutic device and control a functionality of the therapeutic device.

10. The therapeutic device of claim 1, further comprising an aesthetic covering wherein the aesthetic cover is upholstered around the therapeutic device.

11. A method for treating anxiety in a subject, the method comprising:
uprightly positioning a subject on a unified seat, secured to an open-ended suspension, comprising a first vibration contact and second vibration contact, wherein the subject's first ischial tuberosity is positioned over the first vibration contact and the subject's second ischial tuberosity is positioned over the second vibration contact;
activating a first vibration source connected to the first vibration contact so that the first vibration source generates a first vibration at or between about 15 and 30 Hz; and
activating a second vibration source connected to the second vibration contact so that the second vibration source generates a second vibration at or between about 15 and 30 Hz, the second vibration having a frequency different than the first vibration, the first vibration and second vibration differing in frequency by between 0.5 Hz and 2 Hz.

12. The method of claim 11, wherein the first vibration and second vibration cause a traveling wave within the subject having a harmonic frequency between about 45 Hz and 90 Hz, the traveling wave propagating longitudinally through the spine to the head of the subject thereby activating spinal mechanoreceptors.

13. The method of claim 11, wherein the subject is in an upright position so that the subject's spine is vertically oriented relative to the first and second vibration contacts.

14. The method of claim 11, wherein a waveform of at least the first vibration or the second vibration has a harmonic frequency of about 80 Hz.

15. The method of claim 11, wherein the method further comprises monitoring the frequency of the first and second vibrations with a sensor attached to each of the first and second vibration sources.

16. The method of claim 11, wherein waveforms elicit dopamine release in the nucleus accumbens of the subject's brain via activation of spinal mechanoreceptors.

17. A therapeutic device comprising:
a top shell of rigid construction configured for supporting a patient and for transferring vibration into the patient's body;
a first vibrator connected to a first portion of the top shell and configured to cause a first vibration to propagate from the first portion of the top shell;
a second vibrator connected to a second portion of the top shell and configured to cause a second vibration to propagate from the second portion of the top shell, the second vibration having a different frequency than the first vibration, wherein a resulting interference comprises a low frequency traveling wave that propagates from the top shell to the patient's head;
a bottom shell of rigid construction configured to be coupled to the top shell;
a suspension system mechanically coupled to the top shell and configured to vibrationally isolate the top shell from the bottom shell; and
a plurality of vibration isolators secured between the suspension system and the top shell configured to limit vibrational propagation from the top shell to the bottom shell and base.

18. The therapeutic device of claim 17, further comprising a base that is vibrationally isolated from the top shell, comprising a lift mechanism configured to facilitate vertical and rotation adjustments of the therapeutic device.

19. The therapeutic device of claim 17, further comprising a control board and an amplifier configured to electronically interface and control the first vibrator and the second vibrator, wherein the control board and amplifier are coupled to the top shell.

20. The therapeutic device of claim 17, further comprising an interface, the user interface comprising:
one or more inputs configured to control the first vibrator and/or the second vibrators; and
one or more outputs for displaying to the patient a current state of the therapeutic device.
